(19) United States
(12) Patent Application Publication
(10) Pub. No.: US 2013/0006669 A1
(43) Pub. Date: Jan. 3, 2013

(54) Diagnosis Support System, Method and Program

(75) Inventor: Keigo NAKAMURA, Kanagawa-ken (JP)

(73) Assignee: Fujifilm Corporation, Tokyo (JP)

(21) Appl. No.: 13/536,766

(22) Filed: Jun. 28, 2012

(30) Foreign Application Priority Data
Jun. 29, 2011 (JP) 144162/2011

(51) Int. Cl. G06Q 50/24

(52) U.S. Cl. 705/3

(57) ABSTRACT

A constitution information obtainment unit obtains constitution information about a patient to be diagnosed including at least one of genetic information and allergy information about the patient. A comparison constitution information obtainment unit obtains, as comparison constitution information, constitution information about plural patients to be compared. A similar constitution information extraction unit calculates, with respect to the comparison constitution information about the plural patients to be compared, degrees of similarity to the constitution information about the patient to be diagnosed, respectively, and extracts, as similar constitution information, the comparison constitution information the calculated degree of similarity of which satisfies a predetermined threshold condition. A reference information extraction unit extracts, with respect to each extracted similar constitution information, a drug administered to the patient corresponding to the comparison constitution information and drug administration information when the drug was administered to the patient corresponding to the comparison condition information, as reference information.

### BACKGROUND OF THE INVENTION

1. Field of the Invention

The present invention relates to a diagnosis support system, method and program for extracting, based on the constitution of a patient to be diagnosed, diagnosis information about a past patient who has a similar constitution to the constitution of the patient to be diagnosed. In particular, the present invention relates to a diagnosis support system, method and program for extracting, as diagnosis information about a past patient, a drug administered to the past patient and information (drug administration information) obtained in administration of the drug to the past patient.

2. Description of the Related Art

In recent years, electronic diagnosis data became widely used in many medical institutions and facilities, and diagnostic records, medical images and the like of patients became managed by an electronic chart system and PACS (Picture Archiving and Communication Systems). Further, methods for effectively utilizing such electronic diagnosis data began to be proposed. For example, FUJIFILM Corporation proposed a method for retrieving an image similar to a target image of diagnosis from a case database and displaying a retrieval result so that doctors can diagnose a patient, referring to a past case in which the image similar to the target image of diagnosis was obtained (Japanese Unexamined Patent Publication No. 2007-275216 (Patent Document 1)). The case database stores many images used in diagnosis in the past and diagnostic reports including diagnosis results, findings and the like obtained in the diagnosis in the past.

Meanwhile, expectation for tailor-made treatment that matches the constitution of each patient is increasing. For example, it has been found that a treatment result and a side effect of a drug are predictable based on a genotype that represents a drug-metabolizing enzyme of a patient. U.S. Patent Application Publication No. 20090171697 (Patent Document 2) discloses a method for generating a dosage plan based on drug metabolism data corresponding to genotype information about a patient to be diagnosed. The drug metabolism data are obtained by using a population model into which genotype information coding drug-metabolizing enzymes has been incorporated.

Further, in Japanese Unexamined Patent Publication No. 2003-345901 (Patent Document 3), information about plural prescriptions issued to a patient to be diagnosed by plural medical facilities is obtained. Further, a judgment is made as to whether the combination of drugs written in the information about the plural prescriptions is a combination of drugs that needs an attention based on information about combinations of drugs that has been stored in advance. If the combination of the drugs written in the information about the plural prescriptions needs an attention, a dosage schedule of the drugs is set based on an interval of administration of the drugs related to the combination of the drugs, using the information about the combination of drugs.

Further, Japanese Unexamined Patent Publication No. 2006-244260 (Patent Document 4) proposes a tailor-made medical prescription system. In this system, genetic information about a patient that causes an individual variation in susceptibility to a disease and susceptibility to a drug, and a patient ID of the patient are stored in an integrated gene DB after obtainment of a consent of the patient. When doctors issue prescriptions, they make final selection of drugs, dosages of the drugs, administration methods of the drugs, and the like, referring to the genetic information about the patient stored in the integrated gene DB.

However, the method disclosed in Patent Document 1 does not support diagnosis based on the constitution of each patient. The method only extracts and presents a medical image of a past patient similar to a target medical image of image-based diagnosis, and information related to the medical image of the past patient. Further, none of the methods disclosed in Patent Documents 2 through 4 satisfies a demand for extracting and referring to specific information that was obtained in the past when a drug was actually administered to another patient whose constitution is similar to the constitution of a patient to be diagnosed.

### SUMMARY OF THE INVENTION

In view of the foregoing circumstances, it is an object of the present invention to provide a diagnosis support system, method and program that can extract, based on the constitution of a patient to be diagnosed, specific information about a patient in the past whose constitution is similar to the constitution of the patient to be diagnosed. The specific information about the past patient includes a drug administered to the patient and information (drug administration information), such as a result obtained by administering the drug to the patient.

A diagnosis support system of the present invention is a diagnosis support system comprising:

a constitution information obtainment means that obtains constitution information about a patient to be diagnosed including at least one of genetic information about the patient to be diagnosed and allergy information about the patient to be diagnosed;

a comparison constitution information obtainment means that obtains, as comparison constitution information, constitution information about a plurality of patients to be compared with the patient to be diagnosed (hereinafter, also referred to as a plurality of patients to be compared);

a similar constitution information extraction means that calculates, with respect to the obtained comparison constitution information about the plurality of patients to be compared, degrees of similarity to the obtained constitution information about the patient to be diagnosed, respectively, and extracts, as similar constitution information, the comparison constitution information the calculated degree of similarity of which satisfies a predetermined threshold condition; and

a reference information extraction means that extracts, with respect to each extracted similar constitution information, a drug administered to the patient corresponding to the comparison constitution information and drug administration information when the drug was administered to the patient corresponding to the comparison condition information, as reference information.

A diagnosis support method of the present invention is a diagnosis support method comprising the steps of:

obtaining constitution information about a patient to be diagnosed including at least one of genetic information about the patient to be diagnosed and allergy information about the patient to be diagnosed;

obtaining, as comparison constitution information, constitution information about a plurality of patients to be compared with the patient to be diagnosed;

calculating, with respect to the obtained comparison constitution information about the plurality of patients to be compared, degrees of similarity to the obtained constitution information about the patient to be diagnosed, respectively, and extracting, as similar constitution information, the comparison constitution information the calculated degree of similarity of which satisfies a predetermined threshold condition; and

extracting, with respect to each extracted similar constitution information, a drug administered to the patient corresponding to the comparison constitution information and drug administration information when the drug was administered to the patient corresponding to the comparison condition information, as reference information.

A program of the present invention is a diagnosis support program that causes a computer to function as:

a constitution information obtainment means that obtains constitution information about a patient to be diagnosed including at least one of genetic information about the patient to be diagnosed and allergy information about the patient to be diagnosed;

a comparison constitution information obtainment means that obtains, as comparison constitution information, constitution information about a plurality of patients to be compared with the patient to be diagnosed;

a similar constitution information extraction means that calculates, with respect to the obtained comparison constitution information about the plurality of patients to be compared, degrees of similarity to the obtained constitution information about the patient to be diagnosed, respectively, and extracts, as similar constitution information, the comparison constitution information the calculated degree of similarity of which satisfies a predetermined threshold condition; and

a reference information extraction means that extracts, with respect to each extracted similar constitution information, a drug administered to the patient corresponding to the comparison constitution information and drug administration information when the drug was administered to the patient corresponding to the comparison condition information, as reference information.

Here, the term “genetic information” means information that can identify a genotype of a patient. It is desirable that the genetic information specifies, for example, a genotype that can identify a drug metabolizing capacity, as disclosed in Patent Document 2. Such information is desirable because the efficacy of a drug for a patient to be diagnosed is predictable based on the drug metabolizing capacity of the patient to be diagnosed by extracting and referring to drug administration information about the drug when the drug was administered to a patient who has the same gene as the patient to be diagnosed. Further, it is possible to obtain a useful guideline for determining the kind of a drug to be administered to the patient to be diagnosed and the dosage of the drug to be administered to the patient to be diagnosed. Alternatively, it is desirable that the genetic information specifies a genotype that can identify susceptibility to a specific disease. Such information is desirable because it is possible to obtain a useful guideline for treatment of the specific disease for a patient to be diagnosed. When reference information about a patient who has the same gene as the patient to be diagnosed is extracted, if the extracted patient to be compared has experienced the specific disease, it is possible to refer to past drug administration information in the reference information reflecting a mechanism of occurrence of the specific disease.

The “allergy information” may include an allergy type, an allergen (an antigen causing an allergy), and any kind of information related to an allergic disease of a patient. The allergy type classifies allergies into types based the mechanism of occurrence of the allergies. Further, the allergic disease includes, for example, atopic dermatitis, pernicious anemia, rheumatic pneumonia, and drug-induced pneumonia. Such allergy information may be obtained automatically from an electronic chart of a patient in which a result of questioning by a doctor and an anamnesis of the patient are written, information about past examinations, or the like. Alternatively, the allergy information may be obtained by a manual input by a user, or the like.

The term “drug” refers to a chemical substance or substances, a biological substance or substances, such as Chinese medicine, and a combination thereof that are administered to a patient to treat, prevent or control a disease or a symptom of the patient. The drug is not limited to authorized pharmaceutical drugs, but the drug may be a supplement, such as vitamins.

The term “drug administration information” refers to information obtained by administering a drug to each patient. The drug administration information includes at least one of a specific method for administering the drug to each patient, the dosage of the drug administered to each patient, a side effect of each patient and a treatment result of each patient. For example, the drug administration information may include only one of the specific method for administering the drug, the dosage of the drug, a side effect and a treatment result. Alternatively, the drug administration information may include an arbitrary combination or all of them. Further, the drug administration information may include additional information obtainable by administering the drug to each patient.

In the present invention, it is desirable that the constitution information includes a plurality of items representing at least one of the genetic information and the allergy information. Further, it is desirable that the similar constitution information extraction means calculates, based on the plurality of items, each of the degrees of similarity by obtaining a sum of weighting coefficients set for the plurality of items, respectively.

In such a case, each of the constitution information and the comparison constitution information should include a plurality of items when the number of an item or items representing genetic information and the number of an item or items representing allergy information are considered together. For example, each of the constitution information and the comparison constitution information may be composed of only genetic information including a plurality of items. Alternatively, each of the constitution information and the comparison constitution information may be composed of only allergy information including a plurality of items. Alternatively, each of the constitution information and the comparison constitution information may be composed of genetic information including at least an item and allergy information including at least an item.

The weighting coefficients may be set in an arbitrary manner based on a purpose of a user so that an important item is weighted more relative to the other items. Further, all of the plurality of items included in the constitution information may be used to calculate a degree of similarity based on a purpose of a user. Alternatively, a part of the plurality of items included in the constitution information may be used to calculate a degree of similarity.

The same weighting coefficient may be constantly used for the same item. Alternatively, plural weighting coefficients may be used for the same item by switching them from each other.

For example, the constitution information obtainment means may further obtain a drug that has been administered to the patient to be diagnosed. Further, the similar constitution information extraction means may calculate each of the degrees of similarity by switching the weighting coefficients based on the obtained drug that has been administered to the patient to be diagnosed.

Further, the constitution information obtainment means may further obtain drug administration information about a drug that has been administered to the patient to be diagnosed. Further, the similar constitution information extraction means may calculate each of the degrees of similarity by switching the weighting coefficients based on the obtained drug administration information about the drug that has been administered to the patient to be diagnosed.

Further, the constitution information obtainment means may obtain a disease of the patient to be diagnosed. The similar constitution information extraction means may calculate each of the degrees of similarity by switching the weighting coefficients further based on the obtained disease of the patient to be diagnosed.

It is desirable that the reference information extraction means in the diagnosis support system of the present invention includes a reference information output means that processes the obtained reference information based on a predetermined output condition, and outputs the processed reference information, as reference information output information.

Here, the term “predetermined output condition” refers to a necessary condition that is set to output extracted reference information in a desirable form for a user. The predetermined output condition is set in an arbitrary manner so that only necessary information of reference information is output based on a demand of a user. If necessary, the necessary information is converted into easily recognizable information by performing statistic processing on the necessary information, and the converted information is output. The predetermined output condition is set in such a manner because the user has a demand for outputting necessary information of reference information in a easily recognizable manner from various viewpoints based on the purpose of diagnosis or the like. As the predetermined output condition, for example, the condition of statistic processing performed on the reference information and the content of the statistic processing may be set. Alternatively, an item or items of reference information to be output and an item or items of a result of statistic processing to be output may be set as the predetermined output condition. Alternatively, a display option that defines the size, the arrangement or the like of the output item or items on a display screen may be set as the predetermined output condition.

For example, the constitution information obtainment means may further obtain a disease of the patient to be diagnosed. Further, the reference information output means may detect and output the drug administered to the patient corresponding to the comparison constitution information for treatment of the obtained disease, and the drug administration information corresponding to the drug. Here, the term “disease” of the patient to be diagnosed means a target disease of diagnosis performed on the patient to be diagnosed. The disease includes any kind of known disease, for example, such as lung squamous cell carcinoma, lung adenocarcinoma and hepatocellular carcinoma.

The reference information output means may distinguishably output, as recommended reference information, the reference information that satisfies a predetermined condition about a treatment result or a side effect of each drug included in the drug administration information.

Here, the term “predetermined condition” refers to a condition that sets an evaluation standard about a treatment result or a side effect of each drug in which administration of the drug to a patient is recognized to be appropriate by doctors or the like. For example, a range of index values representing the severity of a side effect (the degree of a side effect) may be set. Alternatively, a range of index values representing a treatment result may be set. Further, information of reference information that has the lowest evaluation value representing the severity of the side effect may be output as the recommended reference information. Alternatively, information of the reference information that has the highest index value representing the treatment result may be output as the recommended reference information.

Further, it is desirable that the constitution information obtainment means in the diagnosis support system of the present invention obtains at least one of the height, the weight and the age of the patient to be diagnosed. Further, it is desirable that the reference information extraction means extracts, based on the similar constitution information, at least one of the height, the weight and the age of the patient to be compared corresponding to the similar constitution information. It is desirable that the reference information output means distinguishably outputs the reference information about the patient to be compared who has at least one of the height, the weight and the age close to those of the patient to be diagnosed. For example, the reference information may be output in the order of difference in height between the patient to be diagnosed and the patient to be compared from the smallest difference.

Further, the constitution information obtainment means of the diagnosis support system of the present invention may obtain a symptom of the patient to be diagnosed. Further, the comparison constitution information obtainment means may obtain a symptom of each of the plurality of patients to be compared. The similar constitution information extraction means may calculate the degrees of similarity further based on the obtained symptom of the patient to be diagnosed.

Further, the constitution information obtainment means of the diagnosis support system of the present invention may obtain an image of the patient to be diagnosed. Further, the comparison constitution information obtainment means may obtain images of the plurality of patients to be compared. Further, the similar constitution information extraction means may calculate the degree of similarity based on the obtained image of the patient to be diagnosed.

In the aforementioned case, for example, when a degree of similarity of an image is calculated, the similar constitution information extraction means may calculate the feature value of an image of the patient to be diagnosed and a feature value of an image of a patient to be compared by using the method disclosed in Patent Document 1. Further, the similar constitution information extraction means may calculate a degree of similarity between the two images by comparing the feature values. When the calculated degree of similarity satisfies a predetermined threshold condition, the similar constitution information extraction means may judge that the image of the patient to be diagnosed and the image of the patient to be compared are similar to each other. Further, the degree of similarity may be calculated by accumulating weighting coefficients that have been set in advance for respective items constituting constitution information about the patient to be diagnosed and images of the patient to be diagnosed. The weighting coefficients set for the images may be constant, regardless of the kind of the images. Alternatively, the weighting coefficients may vary based on the kinds of the images.

Further, the constitution information obtainment means may obtain an anamnesis of the patient to be diagnosed including a plurality of diseases. Further, the comparison constitution information obtainment means may obtain an anamnesis of each of the plurality of patients to be compared. Further, the similar constitution information extraction means may calculate the degrees of similarity further based on the obtained anamnesis of the patient to be diagnosed.

According to a diagnosis support system, method and program of the present invention, degrees of similarity between constitution information about a patient to be diagnosed including at least one of genetic information about the patient to be diagnosed and allergy information about the patient to be diagnosed and comparison constitution information about a plurality of patients to be compared with the patient to be diagnosed are calculated. Further, comparison constitution information the calculated degree of similarity of which satisfies a predetermined threshold condition is extracted as similar constitution information. With respect to each extracted similar constitution information, a drug administered to the patient corresponding to the comparison constitution information and drug administration information when the drug was administered to the patient corresponding to the comparison condition information are extracted, as reference information. Therefore, doctors or the like can specifically check a drug administered to a patient to be compared who has constitution very similar to the constitution information about the patient to be diagnosed, and drug administration information about the drug, such as a treatment result and a side effect. Therefore, it is possible to obtain useful information to prescribe a drug based on the constitution of the patient to be diagnosed. Hence, the diagnosis support system, method and program of the present invention can improve the accuracy of diagnosis in treatment of a patient.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission unit is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a diagram illustrating the configuration of a diagnosis support system according to an embodiment of the present invention;

FIG. 2 is a diagram illustrating an example of correspondence table T in which drugs administered to patients to be compared and drug administration information are registered according to an embodiment of the present invention;

FIG. 3 is a flow chart of processing in a diagnosis support system according to an embodiment of the present invention;

FIG. 4 is a diagram illustrating an example of reference information according to an embodiment of the present invention;

FIG. 5 is a diagram illustrating an example of display of reference information output information according to an embodiment of the present invention (display of treatment results);

FIG. 6 is a diagram illustrating an example of display of reference information output information according to an embodiment of the present invention (display of side effects);

FIG. 7 is a diagram illustrating an example of display of reference information output information according to an embodiment of the present invention (display of patient information and dosage); and

FIG. 8 is a diagram illustrating an example of display of reference information output information according to an embodiment of the present invention (display of a list of recommended drugs).

### DESCRIPTION OF THE PREFERRED EMBODIMENTS

Hereinafter, embodiments of the present invention will be described with reference to drawings.

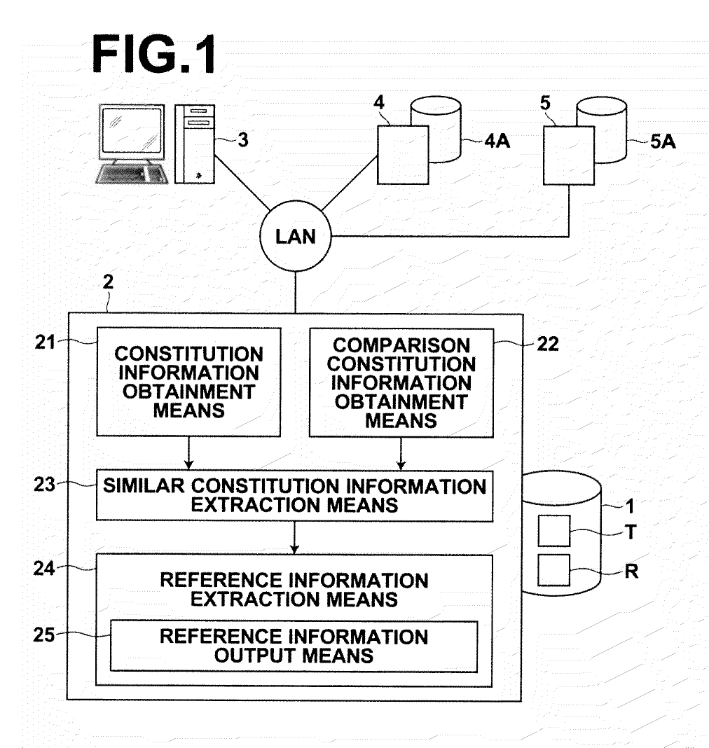

FIG. 1 is a block diagram illustrating the configuration of a diagnosis support system 100 according to a first embodiment of the present invention. The diagnosis support system 100 of the present embodiment includes a reference information management database 1, a reference information management server 2, a WS (workstation) 3 for a clinical department, a diagnosis information database 4A, a diagnosis information management server 4, an image information database 5A, and an image information management server 5. The reference information management database 1 stores reference information in which comparison constitution information about each of plural patients to be compared is related to drugs administered to the respective patients, and to diagnostic data including drug administration information obtained by administering the drugs to the respective patients. The reference information management server 2 manages the reference information management database 1. The diagnosis information database 4A stores diagnosis information about past diseases of plural patients. The image information database 5A includes medical images of patients. The elements configuring the diagnosis support system 100 are connected to each other through a network.

The WS 3 for a clinical department is a computer used by a doctor in the clinical department to observe an image in detail, to retrieve an image interpretation report, to retrieve an electronic chart, to input data into the electronic chart, or the like. The WS 3 for a clinical department has a known hardware configuration, including a CPU, a main storage device, an auxiliary storage device, an input/output interface, a communication interface, an input device 31, a display device 32, a data bus and the like. Further, a known operation system or the like has been installed on the WS 3 for a clinical department. The WS 3 for a clinical department includes the display device and one or two high definition displays. The WS 3 for a clinical department is used to perform processing, such as requesting retrieval of an image from the image information management server 5, displaying the image received from the image information management server 5, requesting retrieval of diagnosis information from the diagnosis information management server 4, displaying the diagnosis information received from the diagnosis information management server 4, requesting registration of patient information or the like in the diagnosis information management server 4, requesting retrieval of patient information from the diagnosis information management server 4, and displaying reference information or the like received from the reference information management server. The processing is performed by execution of a software program for each processing.

A diagnosis support program of the present embodiment installed on the reference information management server 2 and the WS 3 for a clinical department is composed of program module groups for realizing various functions, and the program module groups include a program module group for realizing a diagnosis support function. A part of the programs that is essential for execution of the programs is stored in the reference information management server 2 and a storage of the WS 3 for a clinical department. The part of the programs is loaded into a memory at boot-up, and executed by a processor. The WS 3 for a clinical department receives, based on execution of the diagnosis support program, an input of the constitution of a patient to be diagnosed by the input device 31. Further, the WS 3 for a clinical department sends the received constitution information to the reference information management server 2, and requests the reference information management server 2 to extract and send reference information. Further, the WS 3 for a clinical department receives information output from the reference information management server 2, and displays the information on the display device 32.

The reference information management server 2 is a general-purpose relatively-high-processing-performance computer on which a software program providing a function of database management system (DataBase Management System: DBMS) has been installed. The reference information management server 2 includes a large capacity storage in which the reference information management database 1 is configured. This storage may be a large capacity hard disk drive connected to the reference information management server 2 through a data bus. Alternatively, the storage may be a NAS (Network Attached Storage) connected to a network, or a disk drive connected to a SAN (Storage Area Network).

When the reference information management server 2 receives constitution information about a patient to be diagnosed including at least one of genetic information and allergy information and a request for sending reference information from the WS 3 for a clinical department, the reference information management server 2 functions as a constitution information obtainment means 21, a comparison constitution information obtainment means 22, a similar constitution information extraction means 23, and a reference information extraction means 24 by execution of the diagnosis support program of the present embodiment. The constitution information obtainment means 21 obtains the received constitution information about the patient to be diagnosed. The comparison constitution information obtainment means 22 obtains, as comparison constitution information, constitution information about plural patients to be compared. The similar constitution information extraction means 23 calculates, with respect to the obtained comparison constitution information about each of the plural patients, a degree of similarity to the obtained constitution information about the patient to be diagnosed, and extracts, as similar constitution information, comparison constitution information the calculated degree of similarity of which satisfies a predetermined threshold condition. With respect to each extracted similar constitution information, the reference information extraction means 24 extracts, as reference information, a drug administered to a patient corresponding to comparison constitution information and drug administration information when the drug was administered to the patient corresponding to the comparison constitution information. In the present embodiment, the reference information extraction means 24 includes a reference information output means 25. The reference information output means 25 processes the obtained reference information based on a predetermined output condition, and outputs the processed reference information, as reference information output information.

The reference information management database 1 stores correspondence table T and reference information table R extracted from the correspondence table T. With respect to plural comparison target patients (patients to be compared), the correspondence table T shows correspondence between a drug administered to a patient who has constitution information and drug administration information when the drug was administered to the patient corresponding to the constitution information. The correspondence table shows such correspondence for each constitution information registered in the diagnosis information database 4A, and which includes at least one of genetic information and allergy information about each of the patients to be compared.

In the present embodiment, the constitution of each patient is defined, as constitution information, by a combination of genetic information and allergy information. The constitution information may be composed of only genetic information, or only allergy information. Alternatively, the constitution information may be composed of both of the genetic information and the allergy information.

Further, a genotype is defined as genetic information, because a drug metabolizing capacity and susceptibility to a specific disease are predictable based on a genotype in some cases. It is possible to appropriately extract reference information about past patients who had drug metabolizing capacities and susceptibilities to a specific disease similar to those of the patient to be diagnosed by judging that patients having the same genotype have similar constitutions. With respect to the past patients who had drug metabolizing capacities similar to the drug metabolizing capacity of the patient to be diagnosed, if the drug administered to the patients and information (drug administration information) obtained by administration of the drug are extracted, it is possible to present useful information for a doctor or the like to select an appropriate kind of drug and an appropriate administration method based on the efficacy of the drug. Further, when a genotype that can be used to estimate a perceptibility to a specific disease is defined as genetic information, the likelihood of extracting reference information about past patients who had genes susceptible to the specific disease becomes high. In other words, the likelihood of extracting information about past patients who experienced the specific disease becomes high. Therefore, when the patient to be diagnosed does not have the specific disease yet, it is possible to present appropriate information for a doctor or the like to prevent the specific disease. If the patient to be diagnosed has the specific disease already, it is possible to present useful information about the kind of a drug administered in the past for treatment of the same specific disease and an administration method to a doctor or the like.

Further, an allergy type is defined as allergy information. This is because it is possible to extract an antiallergic drug administered to a patient who experienced an allergic disease of the same allergy type as the allergy type of the patient to be diagnosed, and information (drug administration information) obtained by administration of the drug by judging that patients who have experienced an allergic disease of the same allergy type have similar constitutions. When the patient to be diagnosed has an allergic disease of a specific allergy type, if an antiallergic drug administered to a past patient to be compared who had the allergic disease of the same allergy type as the allergy type of the patient to be diagnosed, and drug administration information are extracted, it is possible to present useful information for selection of an appropriate kind of antiallergic drug and an administration method by a doctor or the like.

In the present embodiment, the constitution of each patient is defined, as constitution information, by a combination of genetic information and allergy information. This is because factors determining the constitution of each patient are various kinds of combination of plural items representing genetic information and allergy information.

Conventionally, an appropriate drug and a treatment plan including administration of the drug were proposed based on only an item of constitution information, such as a genotype. However, real constitutions of patients are in various forms. Therefore, plural items should be considered as the constitution information in some cases. Since a drug recommended based on only an item of constitution information is not always appropriate with respect to a different item of constitution information, the conventional method was insufficient to satisfy a demand by a doctor or the like in practical situations. In other words, when plural items determine the constitution of a patient, the conventional method could not provide a useful proposal on how the plural items should be evaluated in selection of a drug.

Therefore, the present invention has focused on the findings that diagnosis information about a past patient who has a combination of items representing constitution information similar to the combination of items representing constitution information about the patient to be diagnosed, and especially drug administration information about a drug can be utilized as extremely important information to set a treatment policy for the patient to be diagnosed.

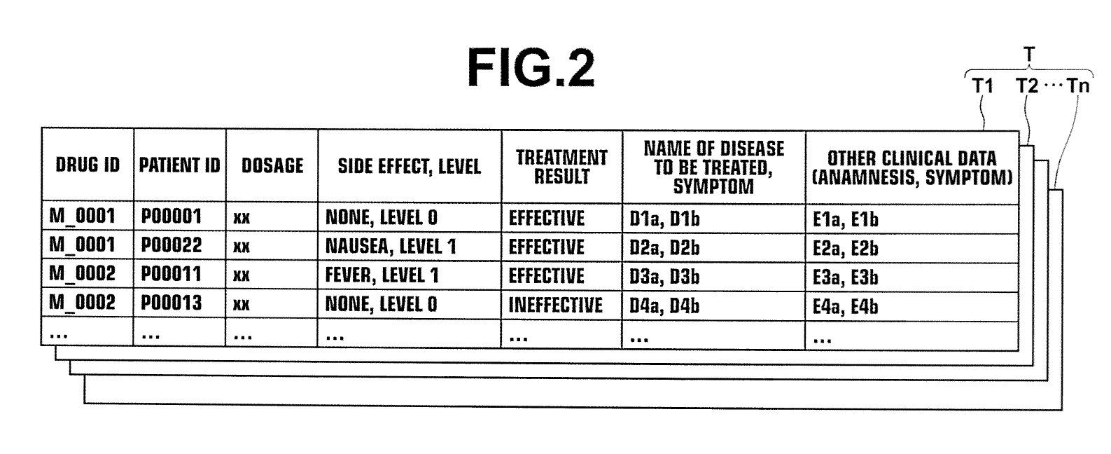

FIG. 2 is a diagram illustrating correspondence table T including plural correspondence tables T1, T2, . . . Tn. In correspondence table T illustrated in FIG. 2, correspondence tables T1, T2, . . . Tn (n is a natural number) for combinations C1, C2, . . . Cn, respectively, are generated and stored. Each of the combinations C1, C2, . . . Cn is a combination of a genotype or genotypes and an allergy type or types that are constitution information about each patient registered in the past diagnosis information. The constitution information C1, C2, . . . Cn (n is a natural number) is defined by an arbitrary combination of genotype ID (g0001, g0002, . . . ) that represents a specific genotype, and allergy type ID (a0001, a0002, . . . ) that represents a specific allergy type. The constitution information may include only at least one genotype ID, or only at least one allergy type ID. Alternatively, the constitution information may be a combination of at least one genotype ID and at least one allergy type ID. Hereinafter, in the specification of the present application, the term “each item constituting constitution information” means each of an genotype ID and an allergy ID.

As illustrated in FIG. 2, correspondence tables T1, T2, . . . Tn for constitution information C1, C2, . . . Cn, respectively, are provided based on diagnosis information about each patient. Each of correspondence tables T1, T2, . . . Tn shows correspondence between drugs and drug administration information when the drugs were administered to each patient. As the drug administration information, the dose of a drug, an administration method, such as a period of administration of the drug and the number of times of administration of the drug, a side effect, and a treatment result are registered. In the present embodiment, the name of a disease of a patient treated by administration of each drug and a symptom of the patient are related to each drug. Further, clinical data, such as the name of a past disease (anamnesis) and a symptom of the past disease, are also related to the drug administered to each patient.

Correspondence table T in the reference information management database 1 may be created based on all kinds of diagnosis information, such as electronic charts of plural patients, stored in the diagnosis information database 4A and images of plural patients stored in the image information database 5A. Necessary information is automatically collected from the diagnosis information and the images based on patient ID's of plural past patients to be compared. Further, the retrieval result is classified, based on each patient ID and constitution information corresponding to the patient ID, into groups of different constitution information, and the groups of different constitution information are related to correspondence tables, respectively. Accordingly, the correspondence table T is created. The correspondence table is not limited to the correspondence table in the present embodiment. The correspondence table may be created for each constitution information by manually inputting a drug and drug administration information, information about each examination, and diagnosis information, such as a result of questioning by a doctor, about each patient to be compared.

Correspondence table T is not limited to the present embodiment. The correspondence table T may be created any time as long as the correspondence table T is ready when reference information extraction processing is performed. The correspondence table T may be created before executing the diagnosis support program of the present embodiment. Alternatively, the correspondence table T may be created after calculating a degree of similarity. In the present embodiment, the correspondence table T is created before execution of the diagnosis support program, and the correspondence table T is created for each constitution information about all of patients to be compared. In such a case, a part of information registered in the correspondence table T is extracted as reference information.

Further, the correspondence table T may be in any format as long as constitution information, drugs and drug administration information are related to each other. For example, the correspondence table T illustrated in FIG. 2 is composed of plural tables into which the correspondence table T is divided for each constitution information. Alternatively, the correspondence table T may be composed of a single correspondence table in which a patient ID, a genotype, an allergy type, a drug ID, a dosage, a side effect and the severity of the side effect, a treatment result, the name of a disease to be treated and the symptom of the disease, and other clinical data (anamnesis, symptom) are related to each other. In such a correspondence table, when plural different drugs have been administered to the same patient, different rows should be used for the different drugs, respectively.

Further, creation of the correspondence table may be omitted. In such a case, only constitution information about each patient to be compared may be obtained from the diagnosis information database 4A when processing for extracting similar constitution information is performed. Further, a degree of similarity between the obtained constitution information and constitution information about the patient to be diagnosed may be calculated, and similar constitution information may be extracted. Further, a patient ID corresponding to the extracted similar constitution information may be obtained, and a drug related to the patient ID, and diagnosis information, such as drug administration information, may be detected in diagnosis information database 4A. Further, the detected information may be related to each other, and used as reference information.

The diagnosis information management server 4 is a general-purpose relatively-high-processing-performance computer on which a software program providing a function of database management system (DataBase Management System: DBMS) has been installed. When the diagnosis information management server 4 receives a request for registration of diagnosis information, such as an electronic chart, from the WS 3 for a clinical department, the diagnosis information management server 4 registers the diagnosis information in the diagnosis information database 4A after changing the format of the diagnosis information in an appropriate manner for the database.

The diagnosis information database 4A stores basic information about a patient, such as the height, the weight and the age of the patient, information about a currently-treated disease of the patient, and information about a past disease of the patient. The information about the currently-treated disease of the patient includes, for example, the name of the currently-treated disease, information about various kinds of examination, and a diagnosis report about the currently-treated disease. The information about the past disease of the patient includes, for example, an anamnesis, such as allergic diseases and a surgical history, a diagnosis report about each past disease in the anamnesis, various kinds of examination data related to the past disease, and the like. Further, information about a past disease and a currently-treated disease, such as information about the position of a region of interest, findings, a drug administration history, a treatment result, a side effect, and results of various kinds of examination, is registered in the diagnosis report. Further, the diagnosis information database 4A may store an examination number and a patient number obtained by referring to supplementary information of image information when image reading is performed on an image for diagnosis. Further, the diagnosis information database 4A may store image data per se of an image on which image reading is performed or image data per se of a representative image, and examination numbers of various kinds of examination. An image reading report may be managed, for example, as XML data or SGML data.

When the diagnosis information management server 4 receives a retrieval request from the WS 3 for a clinical department or the reference information management server 2 through a network, the diagnosis information management server 4 retrieves diagnosis information registered in the diagnosis information database 4A. Further, the diagnosis information management server 4 sends the extracted diagnosis information to the WS 3 for a clinical department or the reference information management server 2 that has requested the diagnosis information.

The image information management server 5 is a general-purpose relatively-high-processing-performance computer on which a software program providing a function of database management system (DataBase Management System: DBMS) has been installed. The image information management server 5 is a so-called PACS (Picture Archiving and Communication Systems) server. The image information management server 5 includes a large capacity storage in which the image information database 5A is configured. The storage may be a large capacity hard disk drive connected to the image information management server 5 through a data bus. Alternatively, the storage may be a NAS (Network Attached Storage) connected to a network, or a disk drive connected to a SAN (Storage Area Network).

The image information database 5A registers image data representing an image of a subject and supplementary information. The supplementary information may include, for example, an image ID for identifying each individual image, a patient ID for identifying a subject, an examination ID for identifying examination, a unique ID (UID) allocated to each image information, an examination date on which the image information was generated, examination time, the kind of a modality used in the examination to obtain the image information, patient information, such as the name, the age, and the sex of the patient, an examined region (an imaged region by radiography or the like), a radiography condition (whether a contrast agent has been used, the dose of radiation, and the like), and information, such as a series number and a collection number, when plural images were obtained in one examination. Further, the image information may be managed, for example, as XML data or SGML data.

When the image information management server 5 receives a request for registration of image information from a WS for a QA, which is not illustrated, the image information management server 5 registers the image information in the image information database 5A after changing the format of the image information in an appropriate manner for the database. When the image information management server 5 receives a retrieval request from the WS 3 for a clinical department or the reference information management server 2 through a network, the image information management server 5 searches image information registered in the image information database 5A, and sends the extracted image information to the WS 3 for a clinical department or the reference information management server 2 that has requested the information.

The image information database 5A stores many medical images of a region of a patient, as a subject, obtained by using a CT apparatus, an MRI apparatus, a PET apparatus, an X-ray radiography apparatus, or the like. Many medical images such as CT images, MRI images, PET images, and plain roentgenograms that are case images used in diagnosis in the past are stored for each subject and for each diagnosis. Processing result information obtained in processing performed in past diagnosis has been attached to the case images. The processing result information includes various kinds of feature values calculated about an image, information about the position of an ROI set in the image, the feature value calculated about an image of the ROI, and the like.

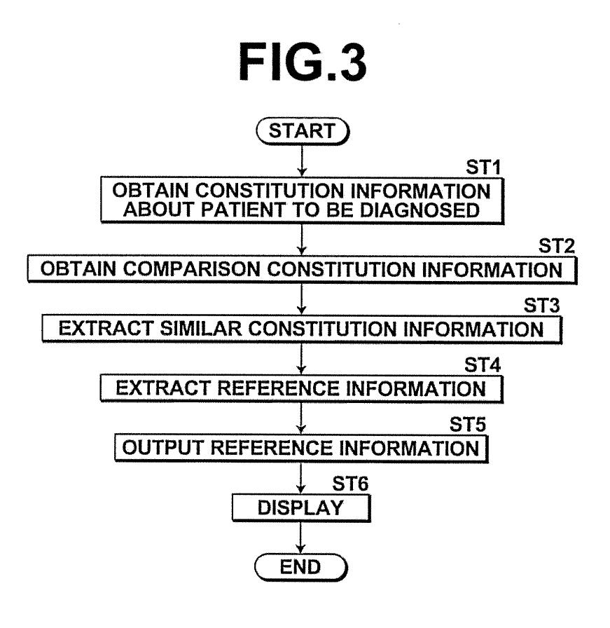

Next, the function of the diagnosis support system of the present embodiment, which is configured as described above, will be described with reference to a flow chart. FIG. 3 is a flowchart of processing in the diagnosis support system of the present embodiment. First, an operator (user) at a terminal of a clinical department inputs plural different kinds of genotypes and allergy types of a patient to be diagnosed, as constitution information, by using an input device 31. Then, the WS 3 for a clinical department receives the input constitution information. The WS 3 for the clinical department sends the constitution information received by a CPU of the terminal of the clinical department to the reference information management server 2 through a network, and makes a display device 32 of the WS 3 for the clinical department display the constitution information. Further, the WS 3 for the clinical department requests the reference information management server 2 to send reference information.

Then, the constitution information obtainment means 21 obtains constitution information about the patient to be diagnosed that has been sent from the WS 3 for the clinical department through a network (step ST1).

Next, the comparison constitution information obtainment means 22 obtains, as comparison constitution information, constitution information C1, C2, . . . Cn about plural patients to be compared from correspondence table T (step ST2). The step ST2 for obtaining comparison constitution information may be performed parallel with the step ST1. Alternatively, the step ST2 may be performed before the step ST1.

Further, the similar constitution information extraction means 23 calculates the degree of similarity of each obtained comparison constitution information to the obtained constitution information about the patient to be diagnosed. Further, the similar constitution information extraction means 23 extracts, as similar constitution information, comparison constitution information the calculated degree of similarity of which satisfies a predetermined threshold condition. Specifically, the calculated degrees of similarity are compared with a predetermined threshold value, and comparison constitution information the degree of similarity of which is greater than or equal to the predetermined threshold value is extracted as similar constitution information (step ST3).

Specifically, the similar constitution information extraction means 23 obtains weighting coefficients that have been set in advance for a genotype and an allergy type, which are items constituting the constitution information about the patient to be diagnosed. Further, the similar constitution information extraction means 23 detects, with respect to each comparison constitution information C1, C2, . . . Cn, a genotype or an allergy type constituting the constitution information about the patient to be diagnosed. The similar constitution information extraction means 23 calculates the degree of similarity between the constitution of the patient to be diagnosed and the comparison information by accumulating weighting coefficients corresponding to the detected genotype or allergy type. Further, the similar constitution information extraction means 23 extracts, as similar constitution information, comparison constitution information the calculated similarity of which is greater than or equal to a predetermined threshold value. Here, it is assumed that comparison constitution information C5, C6 are extracted as similar constitution information.

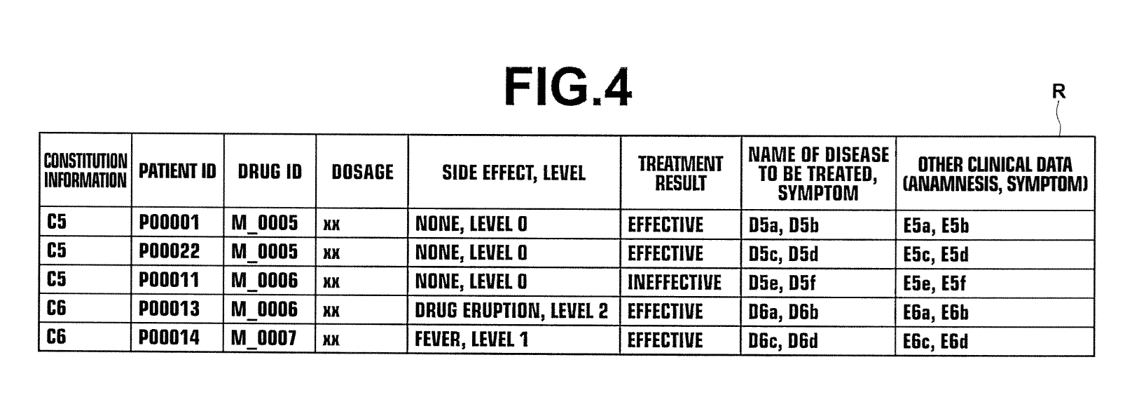

The reference information extraction means 24 extracts, based on a correspondence table of correspondence table T corresponding to the extracted similar constitution information, a drug administered to a patient corresponding to the similar constitution information and drug administration information when the drug was administered to the patient corresponding to the comparison constitution information, as reference information (step ST4). FIG. 4 is reference information table R showing reference information. As illustrated in FIG. 4, the reference information extraction means 24 may further extract, as the reference information, arbitrary information corresponding to similar constitution information C5, C6 in addition to the drug and the drug administration information.

As illustrated in FIG. 4, in the present embodiment, comparison constitution information C5, C6 is extracted as similar constitution information. Further, correspondence tables T5, T6 corresponding to the extracted comparison constitution information C5, C6, respectively, are combined as reference information table R, and the reference information table R is extracted as reference information. Here, for the purpose of explanation, a few cases are registered in correspondence table T5 corresponding to comparison constitution information C5, and a few cases are registered in correspondence table T6 corresponding to comparison constitution information C6.

Next, the reference information output means 25 extracts, based on various kinds of set output options (predetermined output conditions), necessary information from the extracted reference information table R. Further, the reference information output means 25 performs statistic processing on the extracted information, if necessary, and outputs the information, as reference information output information (step ST5).

In the present embodiment, the output options used by the reference information output means 25 have been received by the input device 31 at the WS 3 for the clinical department and sent to the reference information management server 2. The reference information output means 25 obtains the output options specified by an input operation by a user at the WS 3 for the clinical department. Further, the reference information output means 25 extracts, based on the obtained output options, necessary information from the extracted reference information table R. Further, the reference information output means 25 performs statistic processing on the extracted information, if necessary, and outputs (sends) the information, as reference information output information, to the WS 3 for the clinical department.

The output options set necessary conditions to output extracted reference information in a desirable form for a user. The output options are set in an arbitrary manner so that only necessary information of reference information is output based on a user's demand after the information is converted into easily recognizable information by performing statistic processing, if necessary. The output options are, for example, a condition of performing statistic processing on reference information and the content of statistic processing, or items to be output of reference information or a result of statistic processing performed on the reference information, or display options about the items to be output, such as arrangement in a display screen, or the like. The output options may be set by using an arbitrary known method. Alternatively, the output options may be set, in advance, as initial values of a program. Alternatively, when reference information is displayed, a window for selecting a display option may be displayed, and selection by a user may be received to set the output options. Selection by the user may be received by a pull-down menu or the like.

Finally, the WS 3 for the clinical department receives the reference information, and displays the reference information output information, based on the display options set in the output options, on the display device 32 (step ST6).

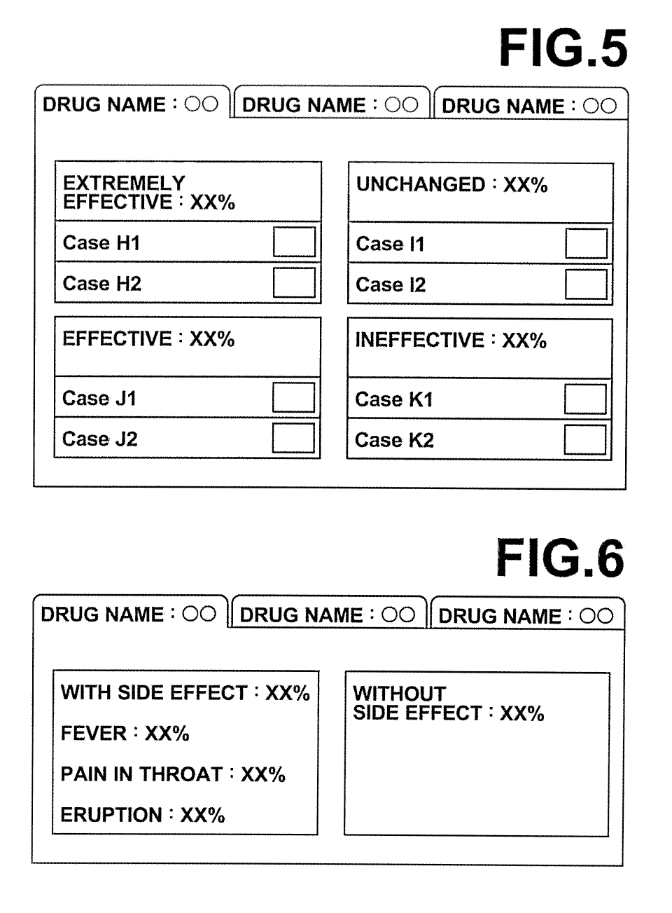

FIGS. 5 through 8 are diagrams illustrating various examples of display of reference information output information output by the reference information output means 25. FIG. 5 is a so-called image diagram illustrating a display screen in which reference information output information is displayed for each treatment result included in drug administration information. For example, when a treatment result included in the drug administration information is classified into four ranks, namely, “extremely effective”, “effective”, “unchanged (no change)” and “ineffective”, for each drug, the reference information output means 25 may output information, as illustrated in FIG. 5. With respect to each registration information registered in reference information table R, the reference information output means 25 may perform statistic processing for each drug to calculate the ratio of ranks of the treatment result included in the drug administration information, and output the ratio of ranks of the treatment result (hereinafter, a set of data including a drug, a patient ID, drug administration information, the name of a disease to be treated, the symptom of the disease to be treated, and other clinical data (anamnesis, and symptoms of diseases included in the anamnesis) that are related to each other, as illustrated in FIG. 4, will be referred to as apiece of registration information). In FIG. 5, each registration information included in reference information table R is displayed as a list for each rank in such a manner that each registration information is selectable. Further, when an image representing a case of a patient to be compared has been attached to registration information in the reference information table R, the image is displayed, as a thumbnail, at the same time. For example, registration information in which a treatment result in drug administration information was extremely effective is displayed as Case H1, and Case H2 in a list. When characters of Case H1, Case H2 are clicked, registration information about Case H1, Case H2, respectively, is displayed in detail. Further, when a thumbnail displayed on the right side of Case H1 is clicked, an image corresponding to the thumbnail is displayed in an enlarged size.

FIG. 6 is a so-called image diagram displaying reference information that is output for each side effect included in the drug administration information. The reference information output means 25 may perform statistic processing on each registration information registered in the reference information table for each drug based on presence or absence of a side effect and the kind of the side effect included in the drug administration information, and output the ratio of presence or absence of a side effect and the ratio of kinds of side effects for each drug, as illustrated in FIG. 6.

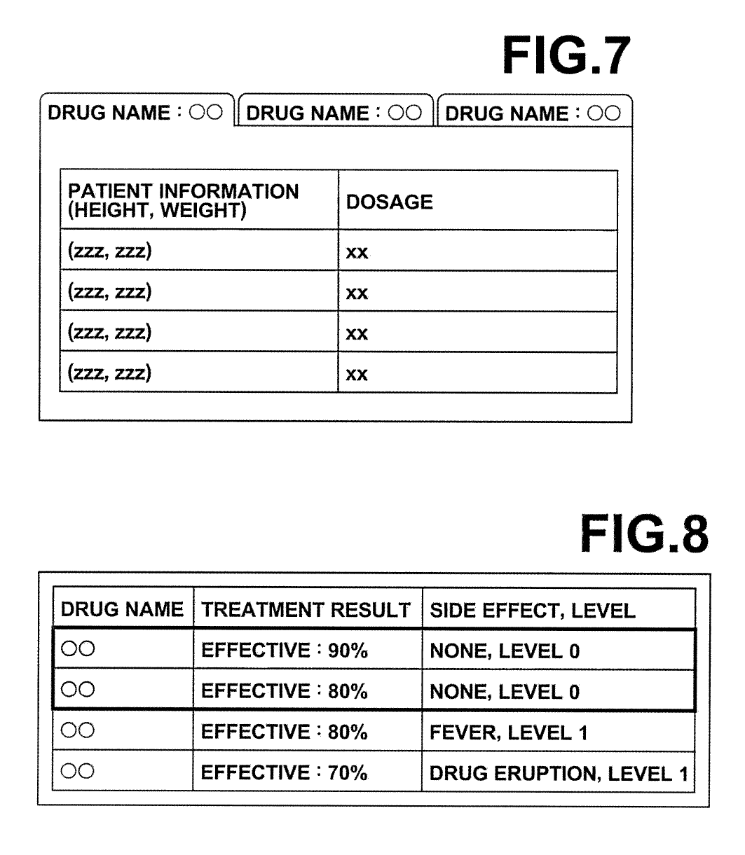

Further, the reference information output means 25 may distinguishably output reference information about a patient to be compared who has at least one of the height, the weight and the age close to those of a patient to be diagnosed. FIG. 7 is a so-called image diagram of a display screen that displays reference information output information. Patient information including the height and the weight of a patient to be compared that are included in drug administration information and the dose of a drug administered, at a time, to each patient to be compared are output, as the reference information output information, and displayed. In this example, the constitution information obtainment means 21 and the comparison constitution information obtainment means 22 obtain patient information about a patient to be diagnosed and patient information about a patient to be compared corresponding to each similar constitution information, respectively. In this example, the reference information output means 25 sorts each registration information registered in reference information table R in order of difference in height between a patient to be diagnosed and a patient to be compared from a smallest difference, and outputs patient information and only the dosage of administered drug in drug administration information. The registration information may be sorted by using the weight or the age instead of the height, and output. Alternatively, the registration information may be sorted by using an arbitrary combination of height, weight and age, and output. For example, an arbitrary combination of a difference in height, a difference in weight, and a difference in age may be weighted, and added. Further, the registration information may be sorted in order of the added values from the smallest value, and output. Instead of sorting and outputting, for example, the height may be classified into plural groups of every 10 cm, namely, less than 140 cm, higher than or equal to 140 cm and less than 150 cm, higher than or equal to 150 cm and less than 160 cm, higher than equal to 160 cm and less than 170 cm, higher than or equal to 170 cm and less than 180 cm, higher than or equal to 180 cm and the like. Further, when the height of the patient to be diagnosed and the height of the patient to be compared belong to the same group, it may be judged that the height of the patient to be diagnosed and the height of the patient to be compared are within a predetermined neighborhood range. Further, reference information only about the patient to be compared in a predetermined neighborhood range may be output. Further, each of the weight and the age may be classified into groups of predetermined unit. Accordingly, it is possible to extract and output reference information only about the patient to be compared who is in a predetermined neighborhood range also with respect to the weight and the age by using a similar method.

The reference information output means 25 may distinguishably output, as recommended reference information, reference information that satisfies a predetermined condition (recommended condition) about a treatment result or a side effect of each drug included in drug administration information. FIG. 8 is a so-called image diagram illustrating a display screen in which drugs, as reference information, are displayed in a list.

The recommended condition sets an evaluation standard for administration of each drug to a patient with respect to the treatment result or the side effect of each drug, which is admitted to be appropriate by doctors or the like. Here, an index value representing the severity of a side effect is set in such a manner that the index value becomes larger as the severity of the side effect is higher. Further, an index value representing the treatment result is set in such a manner that the index value becomes larger as the treatment result is more effective (more excellent improvement of the symptom is recognized). Further, conditions in which the index value of the side effect of the drug is less than or equal to a first threshold value that is judged to be acceptable by doctors or the like, and the index value of the treatment result of the drug is greater than or equal to a second threshold value that is judged by doctors or the like as a level at which the drug achieves an appropriate effect, are set as recommended conditions. In this case, the reference information output means 25 extracts, as recommended drug administration information, drug administration information in which the side effect is less than or equal to a predetermined level and the treatment result is greater than or equal to a predetermined level, and sufficiently effective. Further, the reference information output means 25 extracts, as a recommended drug, a drug corresponding to the recommended drug administration information. Further, the reference information output means 25 distinguishably outputs the recommended reference information including the extracted recommended drug and the extracted recommended drug administration information. Further, as illustrated in FIG. 8, the WS 3 for a clinical department displays the recommended reference information, based on a display option that is set in output options, by adding a thick frame surrounding the recommended reference information.

Further, the recommended reference information may be displayed in color so as to be easily distinguishable. Further, the recommended reference information may be output only based on a side effect, and registration information in which the severity of the side effect is the lowest may be output as the recommended reference information. Alternatively, the recommended reference information may be output only based on a treatment result, and registration information in which the best treatment result is obtained may be output as the recommended reference information.

In FIG. 8, with respect to each registration information registered in reference information table R for each drug, the reference information output means 25 calculates and outputs the ratio of the number of registered cases in which each drug is judged to be effective. Further, the reference information output means 25 extracts and outputs all kinds of side effect registered in the reference information table for each drug. In FIG. 8, each drug and drug administration information corresponding to each drug are arranged in order of the efficacy of the drug in the treatment result from the most effective one, and displayed as a list. Here, the recommended condition may be set in an arbitrary manner based on the purpose of diagnosis. Further, the reference information output means 25 may arrange each drug and drug administration information corresponding to each drug in order of the severity of side effect from the lowest severity of side effect.

Further, the constitution information obtainment means 21 may further obtain a disease of the patient to be diagnosed. Further, the reference information output means 25 may detect only a drug administered to the patient corresponding to the comparison constitution information for treatment of the obtained disease and drug administration information corresponding to the drug in the reference information, and output the detected information. Accordingly, it is possible to specifically present the drug administered to a past patient who has a similar constitution to the patient to be diagnosed for treatment of the same disease as the patient to be diagnosed and a treatment result of the drug or the like to doctors or the like. Therefore, it is possible to support appropriate selection of the kind of a drug and an administration method of the drug, or the like. Further, since information about treatment of other diseases is not displayed, it is possible to easily recognize necessary reference information about the disease desired by a user.

Further, the reference information output means 25 may output reference information table R by arranging items based on the degree of similarity. For example, the reference information output means 25 may sort the reference information table R in order of the degree of similarity of constitution information from the highest degree of similarity, and output the information as a list. Alternatively, the reference information output means 25 may select a sort method and data to be output from reference information from various viewpoints reflecting a user's demand, and output reference information in an arbitrary manner.

As described above, according to the diagnosis support system of the present embodiment, the degree of similarity to the constitution information about the patient to be diagnosed is calculated, and it is possible to specifically check a drug administered to a patient who has a constitution similar to that of the patient to be diagnosed and drug administration information about the drug, such as a treatment result and a side effect. Therefore, it is possible to obtain useful information to prescribe a drug based on the constitution of the patient to be diagnosed. Hence, it is possible to support improvement of the accuracy of diagnosis.

Further, in the present embodiment, the likelihood of extracting, as similar constitution information, constitution information about a patient to be compared having the same genotype as the patient to be diagnosed is high. Therefore, the likelihood of extracting, as reference information, drug administration information about a patient to be compared who has the same genotype as the patient to be diagnosed is high.

For example, when the genotype of the patient to be diagnosed has a risk factor for a specific disease or the like, it is possible to specifically refer to past cases. For example, it is possible to refer to the kind of a drug administered in treatment of the specific disease caused by the same risk factor or the like and how the drug is administered in the treatment based on the mechanism and the process of occurrence of the specific disease. Further, it is possible to refer to a treatment result of the drug or the like. Therefore, it is possible to provide useful information for appropriately selecting a drug for treatment and a drug for prevention of the disease. Consequently, it is possible to support more accurate and more efficient diagnosis.

Further, when the drug metabolizing capacity for a specific drug is identifiable based on the genotype of the patient to be diagnosed, it is possible to specifically refer to a past case of a patient who has a drug metabolizing capacity similar to that of the patient to be diagnosed to obtain the efficacy of the drug based on the dosage of the drug and the kind of the drug. Therefore, it is possible to provide useful information for appropriately selecting the dosage of the drug, the method for administering the drug, and the kind of the drug. Consequently, it is possible to support more accurate and more efficient diagnosis.

Further, according to the present embodiment, the likelihood of extracting, based on the allergy type of the patient to be diagnosed, reference information about a patient to be compared having the same allergy type as the patient to be diagnosed is high. When an allergic disease of a specific allergy type of the patient to be diagnosed is treated, the likelihood of extracting reference information about a patient to be compared having the allergic disease of the same allergy type as the allergy type of the patient to be diagnosed is high. Therefore, it is possible to specifically refer to a past case to obtain the dosage of an antiallergic drug and the kind of the drug. Therefore, it is possible to provide useful information for appropriately selecting the dosage of the drug, the method for administering the drug, and the kind of the drug. Consequently, it is possible to support more accurate and more efficient diagnosis.

One or an arbitrary combination of various kinds of information related to an allergy type, allergen, and an allergic disease may be defined as allergy information.

When it is known that a patient to be diagnosed has an allergy to a specific drug, as an allergen, based on a past allergic disease and administration history of drugs of the patient to be diagnosed, it is effective to define the specific drug as an allergen. The likelihood of extracting, as similar constitution information, constitution information about a past patient who has an allergy to the specific drug, as an allergen, becomes high. Therefore, it is possible to refer to the kind of a drug selected to suppress an allergic reaction of the patient who has an allergy to the same drug, as an allergen, and the method for administering the drug, the dosage of the drug, the treatment result, or the like. Hence, it is possible to extract extremely useful reference information. Consequently, it is possible to support doctors or the like in selection of the kind of a more appropriate drug for the allergy to the specific drug, the method for administering the drug and the like.

For example, when the kind of an allergic disease is defined as allergy information, the likelihood of extracting, as similar constitution information, constitution information about a past patient who had the same allergic disease becomes high. Therefore, it is possible to refer to the kind of a drug administered to a patient who had the same allergic disease, the method for administering the drug, the dosage of the drug, a treatment result or the like. Hence, it is possible to extract extremely useful reference information. Consequently, it is possible to support doctors or the like in selection of the kind of a more appropriate drug for the allergic disease, the method for administering the drug and the like.

The similar constitution information extraction means 23 of the present embodiment calculates the degree of similarity by weighting and adding coefficients set for plural items, respectively, included in both of constitution information and comparison constitution information. Therefore, it is possible to use weighting coefficients that have been set based on the degree of influence of each item constituting the constitution information for the drug. Hence, it is possible to calculate the degree of similarity in a more flexible and appropriate manner.

Further, it is desirable to extract, as reference information, a drug administered in the past to a patient to be compared who has a similar combination of genetic information and allergy information, as constitution information, to those of the patient to be diagnosed, and drug administration information about the patient to be compared. That is because when the degree of similarity is calculated based on plural items, it is possible to judge the similarity of constitution information more accurately. Further, when the patient to be diagnosed has plural genotypes representing that the patient is susceptible to specific diseases and plural allergy types, and has plural specific diseases and plural allergic diseases corresponding to the plural allergy types, it is necessary to prescribe plural kinds of drug, considering all of the plural specific diseases and the plural allergic diseases into consideration. In such a case, it is possible to support more accurate and more efficient diagnosis by extracting and referring to reference information about a patient to be compared who has a similar combination of genetic information and allergy information to those of the patient to be diagnosed.

In the present embodiment, the reference information output means 25 that performs statistic processing on extracted reference information based on a predetermined output option, and that displays the reference information as illustrated in FIGS. 5 through 8, is provided. Therefore, it is possible to analyze, as statistical values, past treatment data about plural patients in detail. Hence, it is possible to provide useful information to support diagnosis. Further, since the reference information output means 25 extracts and outputs only necessary information of extracted reference information based on a predetermined output option, a user or the like can obtain only necessary information. Hence, it is possible to easily recognize the information. Consequently, doctors or the like can accurately and efficiently recognize the information, and that can improve the accuracy and the efficiency of diagnosis.

As illustrated in FIG. 5, only necessary information may be displayed on a display screen in a simple manner, and detail information included in registration information may be output and displayed by a click operation or the like of a character representing each registration information or a thumbnail representing an image of a patient to be compared by a user. In such a case, the display screen is not complicated, and it is possible to refer to detail information only if necessary. Therefore, a user can refer to the reference information efficiently. When the reference information is classified into each drug, and the treatment result of the drug is displayed for each rank, as illustrated in FIG. 5, a user can recognize the treatment result of the drug by intuition.

Further, the WS 3 for a clinical department displays a display screen by changing items and arrangement of the items on the display screen based on a display option included in output options. Therefore, a user can easily recognize necessary information.

When the reference information is output and displayed based on a side effect, as illustrated in FIG. 6, it is possible to easily recognize information about a side effect of each drug, such as presence or absence of a side effect and the kind of the side effect, and that is desirable.

When the reference information is output and displayed based on the weight and the height of a patient, as illustrated in FIG. 7, it is possible to specifically refer to a drug administered to a patient to be compared who has also a similar height and a similar weight to those of the patient to be diagnosed, and the dosage of the drug in the reference information.

When recommended reference information is distinguishably output and displayed, as illustrated in FIG. 8, a user can easily recognize a recommended drug and drug administration information. Therefore, it is possible to support selection of a drug.

The reference information output means 25 may detect a drug administered to a patient corresponding to comparison constitution information for treatment of an obtained disease and drug administration information about the drug in reference information, and output the detected information. In such a case, it is possible to easily refer to a drug administered to the patient to be compared for treatment of the same disease as the disease of the patient to be diagnosed and drug administration information about the drug. Hence, diagnosis efficiency is high.

In the present embodiment, the name of a disease of a patient to which a drug was administered for treatment and the symptom of the patient are further related, as reference information, to each drug. Further, clinical data, such as a past disease name (anamnesis) and the symptom of the past disease, are also related. Therefore, doctors or the like can recognize the name and the symptom of the disease of the patient to be compared or other information in an anamnesis in addition to a drug and drug administration information. Hence, it is possible to refer to information about a patient to be compared in more detail and accurately.

Further, weighting coefficients for calculating the degree of similarity between constitution information about a patient to be diagnosed and constitution information about a patient to be compared may be set for each item in an arbitrary manner based on the purpose of a user. Next, as a second embodiment, a case in which the similar constitution information extraction means 23 calculates the degree of similarity by switching weighting coefficients for each predetermined item will be described.

For example, the similar constitution information extraction means 23 of the second embodiment may calculate the degree of similarity by switching the weighting coefficients for each drug. For example, a degree-of-similarity calculation table for each drug showing correspondence of weighting coefficients to respective items constituting constitution information may be stored in advance in a database. Further, constitution information about a patient to be diagnosed and a candidate of a drug administered to the patient are obtained by an input by a user using an input device. Further, weighting coefficients corresponding to the obtained drug are obtained based on the degree-of-similarity table. Further, the degree of similarity may be calculated by using the obtained weighting coefficients.

For example, when it is difficult to identify the cause of a disease, such as pneumonia, at an early stage of the disease, different kinds of antibacterial drug are switched and administered to a patient in an appropriate manner to treat the disease in some cases until doctors or the like can identify an antibacterial drug appropriate for the cause of the disease. In such a case, doctors need to pick up plural candidate drugs usable for treatment of the disease to determine the antibacterial drugs to be switched from each other, and to determine a drug that is actually administered to the patient by selecting the drug from the candidate drugs. In such a case, the method for calculating the degree of similarity, as described above, is effective. For example, when doctors or the like input candidate drug MX1 of three candidate drugs MX1, MX2, and MX3, the similar constitution information extraction means 23 switches the weighting coefficients so that weighting for genotype g0001 representing the efficacy of candidate drug MX1 is relatively higher than weighting for other genotypes. Then, when the patient to be diagnosed has genotype g0001 representing the efficacy of the specific drug MX1, the similar constitution information extraction means 23 can extract, as similar constitution information, constitution information about a patient to be compared who has genotype g0001 at higher likelihood of extraction. Therefore, the likelihood that the reference information extraction means 24 can extract reference information, such as a treatment result, of the patient to be compared who has genotype g0001 is high. Hence, doctors or the like can extract reference information about a patient to be compared who has genotype g0001, and refer to information, such as a treatment result achieved by administering candidate drug MX1 to the patient to be compared, included in the reference information. Further, the doctors or the like calculate degrees of similarity for candidate drugs MX2, MX3 in a similar manner to candidate drug MX1. The degree of similarity is calculated by switching the weighting coefficient of a genotype that is closely related to each candidate drug. Further, the doctors or the like refer to information, such as a treatment result achieved by administering candidate drug MX2 or MX3 to the patient to be compared, included in the extracted reference information. Consequently, it is possible to obtain more appropriate reference information based on a candidate drug. Hence, it is possible to select a drug that is actually administered to a patient to be diagnosed from plural candidate drugs in a more appropriate manner.

Weighting coefficients may be set for all of items constituting constitution information (plural genotypes or allergy types, or other allergy information, such as allergen). Alternatively, weighting coefficients may be set only for a part of the items. Further, the kinds of items (plural genotypes or allergy types, or other allergy information, such as allergen) constituting the constitution information for which weighting coefficients are set may be changed based on a drug.

The similar constitution information extraction means 23 in the second embodiment may calculate the degree of similarity by switching weighting coefficients for calculating the degree of similarity for each drug administration information. Specifically, a degree-of-similarity calculation table for each predetermined drug administration information showing correspondence of weighting coefficients to respective items constituting constitution information may be stored in advance in a database. Further, constitution information about a patient to be diagnosed and drug administration information about a drug administered to the patient may be obtained by input by a user using an input means. Further, weighting coefficients corresponding to the obtained drug administration information may be obtained based on the degree-of-similarity calculation table. Further, the degree of similarity may be calculated by using the obtained weighting coefficients.

Further, the similar constitution information extraction means 23 in the second embodiment may calculate the degree of similarity by switching the weighting coefficients for calculating the degree of similarity for each disease of the patient to be diagnosed. Specifically, a degree-of-similarity calculation table for each disease showing correspondence of weighting coefficients to respective items constituting constitution information may be stored in advance in a database. Further, constitution information about a patient to be diagnosed and a disease of the patient to be diagnosed may be obtained by input by a user using an input means. Further, weighting coefficients corresponding to the obtained disease may be obtained based on the degree-of-similarity calculation table. Further, the degree of similarity may be calculated by using the obtained weighting coefficients.

The degree of connection with each item representing the constitution of a patient differs for each disease. Therefore, when a weighting coefficient that has been appropriately set for each disease is used, it is possible to appropriately extract, as similar constitution information, constitution information in which a specific constitution that is especially closely related to the disease is similar. For example, when a specific disease of the patient to be diagnosed is obtained, weighting coefficients may be switched in such a manner that weighting for a genotype related to susceptibility to the specific disease becomes high. Consequently, the likelihood of extracting, as similar constitution information, constitution information having a genotype related to the susceptibility to the specific disease is high.

Further, the similar constitution information extraction means 23 of the second embodiment is not limited to the aforementioned example. The similar constitution information extraction means 23 may calculate the degree of similarity by switching weighting coefficients for calculating the degree of similarity based on an arbitrary combination of a drug, drug administration and a disease of the patient to be diagnosed. Alternatively, the similar constitution information extraction means 23 may calculate the degree of similarity, based on a user's demand, by switching weighting coefficients based on various indices (or a combination of various indices) that are considered to influence prescription of a drug.

As a third embodiment, the similar constitution information extraction means 23 may further set a weighting coefficient for an additional item or items other than the constitution information. Further, the similar constitution information extraction means 23 may calculate the degree of similarity by calculating a sum of weighting coefficients based on both of the constitution information and the additional item or items.

For example, the constitution information obtainment means 21 in the third embodiment may further obtain a symptom of the patient to be diagnosed. Further, the comparison constitution information obtainment means 22 may further obtain symptoms of plural patients. Further, the similar constitution information extraction means 23 may calculate the degree of similarity also based on the obtained symptoms of the patients. In this case, it is possible to calculate the degree of similarity, considering a similarity between the symptoms of the patients as well as a similarity in constitution. Therefore, it is possible to give priority to extraction of diagnostic data about a patient who is similar to the patient to be diagnosed from plural viewpoints. Further, it is possible to extract and provide useful information for diagnosis.

Further, the constitution information obtainment means 21 of the third embodiment may further obtain an image of the patient to be diagnosed. Further, the comparison constitution information obtainment means 22 may further obtain images of plural patients.

Further, the similar constitution information extraction means 23 may calculate the degree of similarity also based on the obtained image of the patient to be diagnosed. In this case, it is possible to calculate the degree of similarity, considering a similarity between images of patients as well as the constitution. Therefore, it is possible to give priority to extraction of diagnostic data about a patient who is similar to the patient to be diagnosed from plural viewpoints. Hence, it is possible to extract and provide useful information for diagnosis.

In the aforementioned case, for example, when a degree of similarity of an image is calculated, the similar constitution information extraction means 23 may calculate the feature value of an image of the patient to be diagnosed and a feature value of an image of a patient to be compared by using the method disclosed in Patent Document 1. Further, the similar constitution information extraction means 23 may calculate a degree of similarity between the two images by comparing the feature values of the images. When the calculated degree of similarity satisfies a predetermined threshold condition, the similar constitution information extraction means 23 may judge that the image of the patient to be diagnosed and the image of the patient to be compared are similar to each other. When it is judged that the image of the patient to be diagnosed and the image of the patient to be compared are similar to each other, the degree of similarity may be calculated by accumulating weighting coefficients that have been set in advance for each item constituting constitution information about the patient to be diagnosed and the image. The weighting coefficient that is set for the image may be constant regardless of the kind of the image. Alternatively, the weighting coefficient may vary based on the kind of an image.

The constitution information obtainment means 21 may further obtain an anamnesis including plural diseases of the patient to be diagnosed. The comparison constitution information obtainment means 22 may further obtain anamneses of plural patients. The similar constitution information extraction means 23 may calculate the degree of similarity also based on the obtained anamnesis of the patient to be diagnosed. In this case, it is possible to calculate the degree of similarity, considering a similarity in anamneses of patients as well as a similarity in constitution of the patients. Therefore, it is possible to give priority to extraction of diagnostic data about a patient that are similar from plural viewpoints. Therefore, it is possible to extract and provide useful information for diagnosis in an appropriate manner. In the present embodiment, information about an allergic disease of a patient among past diseases of the patient is regarded as constitution information. Therefore, the anamnesis refers to past diseases of the patient excluding allergic diseases of the patient.

In each of the embodiments, a correspondence table has been created before obtainment of constitution information about a patient to be diagnosed. Therefore, it is possible to quickly extract and output each information corresponding to similar constitution information. Alternatively, the reference information extraction means 24 may create the correspondence table by extracting only a drug related to identified similar constitution information and drug administration information about the drug from diagnostic information database 4A after extraction of the similar constitution information. In such a case, even if the reference information database 1 is a relatively small capacity storage, it is possible to execute the diagnosis support method.

It is not necessary that each database in the embodiments of the present invention is a single database. Each database may be composed of plural databases. For example, each database may be composed of plural databases present in the same facility or institution. Alternatively, each database may be plural databases scattered in plural different facilities or institutions that are connectable through a network. In other words, the embodiments of the present information include a mode of sharing information stored in databases provided in different facilities.

In the descriptions of the embodiments of the present invention, CT images have been used as diagnosis-target medical images, in other words, retrieval-target medical images. It is needless to say that retrieval of similar images may be performed in a similar manner also to retrieve images obtained by other imaging modalities, such as MRI images, RI images, PET images and X-ray images, other than the CT images.

The present invention is not limited to the embodiments of the present invention. A part or all of elements constituting the diagnosis support apparatus may be configured by a workstation. Alternatively, a part or all of elements constituting the diagnosis support apparatus may be configured by at least one workstation, at least one server, and at least one storage device connected to each other through a network. Further, each device is controlled by a program for performing diagnosis support processing of the present invention. The program may be read out from a recording medium, such as a CD-ROM, and installed. Alternatively, the program may be downloaded from a storage device of a server connected through a network, such as the Internet, and installed.

The embodiments may be applied to other embodiments without departing from the gist of the present invention.

What is claimed is:

1. A diagnosis support system comprising:
a constitution information obtainment unit that obtains constitution information about a patient to be diagnosed including at least one of genetic information about the patient to be diagnosed and allergy information about the patient to be diagnosed;
a comparison constitution information obtainment unit that obtains, as comparison constitution information, constitution information about a plurality of patients to be compared with the patient to be diagnosed;
a similar constitution information extraction unit that calculates, with respect to the obtained comparison constitution information about the plurality of patients to be compared, degrees of similarity to the obtained constitution information about the patient to be diagnosed, respectively, and extracts, as similar constitution information, the comparison constitution information the calculated degree of similarity of which satisfies a predetermined threshold condition; and
a reference information extraction unit that extracts, with respect to each extracted similar constitution information, a drug administered to the patient corresponding to the comparison constitution information and drug administration information when the drug was administered to the patient corresponding to the comparison condition information, as reference information.

2. A diagnosis support system, as defined in claim 1, wherein the constitution information includes a plurality of items representing at least one of the genetic information and the allergy information, and
wherein the similar constitution information extraction unit calculates, based on the plurality of items, each of the degrees of similarity by obtaining a sum of weighting coefficients set for the plurality of items, respectively.

3. A diagnosis support system, as defined in claim 2, wherein the constitution information obtainment unit further obtains a drug that has been administered to the patient to be diagnosed, and
wherein the similar constitution information extraction unit calculates each of the degrees of similarity by switching the weighting coefficients based on the obtained drug that has been administered to the patient to be diagnosed.

4. A diagnosis support system, as defined in claim 2, wherein the constitution information obtainment unit further obtains drug administration information about a drug that has been administered to the patient to be diagnosed, and
wherein the similar constitution information extraction unit calculates each of the degrees of similarity by switching the weighting coefficients further based on the obtained drug administration information about the drug that has been administered to the patient to be diagnosed.

5. A diagnosis support system, as defined in claim 2, wherein the constitution information obtainment unit further obtains a disease of the patient to be diagnosed, and
wherein the similar constitution information extraction unit calculates each of the degrees of similarity by switching the weighting coefficients further based on the obtained disease of the patient to be diagnosed.

6. A diagnosis support system, as defined in claim 2, wherein the reference information extraction unit includes a reference information output unit that processes the obtained reference information based on a predetermined output condition, and outputs the processed reference information, as reference information output information.

7. A diagnosis support system, as defined in claim 6, wherein the constitution information obtainment unit further obtains a disease of the patient to be diagnosed, and
wherein the reference information output unit detects and outputs the drug administered to the patient corresponding to the comparison constitution information for treatment of the obtained disease and the drug administration information corresponding to the drug.

8. A diagnosis support system, as defined in claim 6, wherein the reference information output unit distinguishably outputs, as recommended reference information, the reference information that satisfies a predetermined condition about a treatment result or a side effect of each drug included in the drug administration information.

9. A diagnosis support system, as defined in claim 6, wherein the constitution information obtainment unit further obtains at least one of the height, the weight and the age of the patient to be diagnosed, and
wherein the reference information extraction unit further extracts, based on the similar constitution information, at least one of the height, the weight and the age of the patient to be compared corresponding to the similar constitution information, and
wherein the reference information output unit distinguishably outputs the reference information about the patient to be compared who has at least one of the height, the weight and the age close to those of the patient to be diagnosed.

10. A diagnosis support system, as defined in claim 1, wherein the constitution information obtainment unit further obtains a symptom of the patient to be diagnosed, and
wherein the comparison constitution information obtainment unit further obtains a symptom of each of the plurality of patients to be compared, and
wherein the similar constitution information extraction unit calculates the degrees of similarity further based on the obtained symptom of the patient to be diagnosed.

11. A diagnosis support system, as defined in claim 1, wherein the constitution information obtainment unit further obtains image information about the patient to be diagnosed, and
wherein the comparison constitution information obtainment unit further obtains image information about the plurality of patients to be compared, and
wherein the similar constitution information extraction unit calculates the degrees of similarity further based on the obtained image information about the patient to be diagnosed.

12. A diagnosis support system, as defined in claim 1, wherein the constitution information obtainment unit further obtains an anamnesis of the patient to be diagnosed including a plurality of diseases, and
wherein the comparison constitution information obtainment unit further obtains an anamnesis of each of the plurality of patients to be compared, and
wherein the similar constitution information extraction unit calculates the degrees of similarity further based on the obtained anamnesis of the patient to be diagnosed.

13. A diagnosis support system, as defined in claim 1, wherein the genetic information is a genotype.

14. A diagnosis support system, as defined in claim 1, wherein the drug administration information includes at least one of a side effect of the drug, a dosage of the drug, a method for administering the drug, and a treatment result of the drug.

15. A diagnosis support method comprising the steps of:
obtaining constitution information about a patient to be diagnosed including at least one of genetic information about the patient to be diagnosed and allergy information about the patient to be diagnosed;
obtaining, as comparison constitution information, constitution information about a plurality of patients to be compared with the patient to be diagnosed;
calculating, with respect to the obtained comparison constitution information about the plurality of patients to be compared, degrees of similarity to the obtained constitution information about the patient to be diagnosed, respectively, and extracting, as similar constitution information, the comparison constitution information the calculated degree of similarity of which satisfies a predetermined threshold condition; and
extracting, with respect to each extracted similar constitution information, a drug administered to the patient corresponding to the comparison constitution information and drug administration information when the drug was administered to the patient corresponding to the comparison condition information, as reference information.

16. A computer-readable non-transitory storage medium recording therein a diagnosis support program that causes a computer to function as:
a constitution information obtainment unit that obtains constitution information about a patient to be diagnosed including at least one of genetic information about the patient to be diagnosed and allergy information about the patient to be diagnosed;
a comparison constitution information obtainment unit that obtains, as comparison constitution information, constitution information about a plurality of patients to be compared with the patient to be diagnosed;
a similar constitution information extraction unit that calculates, with respect to the obtained comparison constitution information about the plurality of patients to be compared, degrees of similarity to the obtained constitution information about the patient to be diagnosed, respectively, and extracts, as similar constitution information, the comparison constitution information the calculated degree of similarity of which satisfies a predetermined threshold condition; and
a reference information extraction unit that extracts, with respect to each extracted similar constitution information, a drug administered to the patient corresponding to the comparison constitution information and drug administration information when the drug was administered to the patient corresponding to the comparison condition information, as reference information.
